(19) United States
(12) Patent Application Publication
(10) Pub. No.: US 2012/0046167 A1
(43) Pub. Date: Feb. 23, 2012

(54) Composition containing pesticide, preservative agent and unbranched 1,2-alkanodiol

(75) Inventors: Christian Sowa, Neustadt (DE); John-Bryan Speakman, Bobenheim (DE); Wioletta Kuncewicz-Kupczyk, Sao Paulo (BR)

(73) Assignee: BASF SE, Ludwigshafen (DE)

(21) Appl. No.: 13/266,262

(22) PCT Filed: Apr. 21, 2010
(86) PCT No.: PCT/EP2010/055241

§ 371 Date: Oct. 26, 2011

(30) Foreign Application Priority Data
Apr. 27, 2009 (EP) 09158855.8

(51) Int. Cl. A01C 1/06; A01P 13/00; A01P 7/04; A01P 11/00; A01N 43/54; A01P 3/00

(52) U.S. Cl. 504/100; 514/275; 514/266.23

(57) ABSTRACT

The present invention relates to an agrochemical composition comprising pesticide, preservative and unbranched 1,2-alkanediol having 5 to 10 carbon atoms. The invention furthermore relates to a process for the preparation of this composition in which pesticide, preservative and unbranched 1,2-alkanediol having 5 to 10 carbon atoms are mixed. Moreover, the invention relates to a use of the composition for controlling phytopathogenic fungi and/or undesired plant growth and/or undesired insect or mite attack and/or for regulating the growth of plants, and to a use of the composition for controlling undesired insect or mite attack on plants and/or for controlling phytopathogenic fungi and/or for controlling undesired plant growth, where seeds of useful plants are treated with the composition, and, finally, to seed, treated with the composition.

The present invention relates to an agrochemical composition comprising pesticide, preservative and unbranched 1,2-alkanediol having 5 to 10 carbon atoms. The invention furthermore relates to a process for the preparation of this composition by mixing pesticide, preservative and unbranched 1,2-alkanediol having 5 to 10 carbon atoms. Moreover, the invention relates to a use of the composition for controlling phytopathogenic fungi and/or undesired plant growth and/or undesired insect or mite attack and/or for regulating the growth of plants, and to a use of the composition for controlling undesired insect or mite attack on plants and/or for controlling phytopathogenic fungi and/or for controlling undesired plant growth, where seeds of useful plants are treated with the composition, and, finally, to seed, treated with the composition. Combinations of preferred features with other preferred features are comprised by the present invention.

EP 1 201 125 A1 discloses an endermatic ointment composition comprising 3-methoxybutanol and 1,2-pentanediol. It is furthermore disclosed that the joint use of these products leads to a superior antiseptic effect.

EP 1 426 029 A1 discloses an emulsion composition, with 1,2-alkanediol, surfactant, oily substance and water being present as essential components.

WO 2003/069994 discloses the use of a mixture of two, three or more unbranched 1,2-alkanediols as antimicrobial active substance. By way of further component in the mixture, it is possible to employ an antimicrobial active substance in an amount whereby the antimicrobial activity of the alkanediol mixture is increased synergistically.

Pillai et al. disclose in SÖFW-Journal, 2005, 131(6), 13-22 (“1,2-Pentanediol—a Multifunctional Ingredient for Personal Care Applications”) that 1,2-pentanediol increases the preserving activity of a mixture of the preservatives phenoxyethanol, methylparaben, butylparaben, propylparaben and isobutylparaben in cosmetic formulations.

The use of preservatives in agrochemical preparations has been known for a long time. Without the addition, or with an insufficient addition, of preservatives, various problems result, mainly due to the growth of microorganisms: evolution of gas, so that the plastic canisters or metal barrels with the agrochemical compositions might burst; development of unpleasant odors which, in insecticidal or rodenticidal compositions, might lead to a repellent effect on the insects or rodents; discolorations; pH changes, to which some pesticides are sensitive; changes in the viscosity caused by the degradation of polysaccharide-comprising thickeners, so that problems might arise upon spray application; or phase separation or sedimentation of emulsions or suspensions as the result of microbial degradation of surfactants, which might lead to problems when making up the tank mix and applying the same.

The abovementioned problems reduce in particular the storage stability of the agrochemical preparations since the latter are usually not stored in spaces with a controlled environment, but in the open. In theory, agrochemical compositions might be stabilized for a long period of time by the addition of high concentrations of preservatives, so that the abovementioned problems are little in evidence. However, various preservatives, such as para-hydroxybenzoic acid and its esters, formaldehyde-releasing agents, chlorhexidine, benzalkonium chloride, propionic acid, phenoxyethanol are suspected of being allergenic or toxic.

It was therefore an object of the present invention to find an agrochemical composition comprising pesticide and preservative, which composition features a reduced concentration of preservative. A further object was that the antimicrobial activity of the preservative in the agrochemical composition be very high, even with a reduced concentration. Furthermore, it was an object that the agrochemical composition to be found can furthermore be formulated without problems, that the usual agrochemical formulation adjuvants can be employed, that the usual agrochemical application techniques such as spraying or seed-dressing can be employed, and/or that the insecticidal or rodenticidal activity be not adversely affected by undesirable odor or flavor.

The object was achieved by an agrochemical composition comprising pesticide, preservative and unbranched 1,2-alkanediol having 5 to 10 carbon atoms.

Preferred unbranched 1,2-alkanediols having 5 to 10 carbon atoms are 1,2-pentanediol, 1,2-hexanediol, 1,2-octanediol and 1,2-decanediol. Especially preferred is 1,2-pentanediol. 1,2-Pentanediol is commercially available in various degrees of purity, for example of at least 70% by weight to at least 99.95% by weight. In general, the composition according to the invention comprises from 0.01 to 10% by weight, preferably from 0.1 to 8% by weight, especially preferably from 0.5 to 3% by weight, of the alkanediol.

The expression pesticide (hereinbelow also referred to as plant protection agent) refers to at least one active substance selected from the group consisting of the fungicides, insecticides, nematicides, herbicides, rodenticides, safeners and/or growth regulators, preferably insecticides, nematicides, herbicides, rodenticides, safeners and/or growth regulators. By pesticides, a person skilled in the art usually understands those active substances which are employed in agrochemical compositions

In a preferred embodiment, plant protection agents are substances which are intended for the following purposes: a) to protect plants or live parts of plants and plant products from harmful organisms; b) to protect plants or live parts of plants and plant products from animals, plants or microorganisms which are not harmful organisms; c) to engage in the plants' biological processes without serving for its nutrition (such as growth regulators); and d) to destroy plants or to inhibit or prevent the growth of plants.

A person skilled in the art generally knows that plant protection agents are clearly defined and controlled in legal terms, for example in laws dealing with the licensing of plant protection agents, the limiting of residues in foodstuffs or in drinking water, the protection of bees, the correct use, the ban of dangerous plant protection agents such as DDT or lindane. Therefore, a person skilled in the art clearly distinguishes between plant protection agents (such as fungicides) and pharmaceuticals (such as antimycotics, antibiotics or disinfectant) or substances employed in cosmetics.

Preferred pesticides are fungicides, insecticides, rodenticides and herbicides, insecticides, rodenticides and herbicides being particularly preferred. Mixtures of pesticides of two or more of the abovementioned classes may also be used. The skilled worker is familiar with such pesticides, which can be found, for example, in Pesticide Manual, 14th Ed. (2006), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds, nereistoxin analogs, benzoylureas, diacylhydrazines, METI acaricides, and insecticides such as chloropicrin, pymetrozine, flonicamid, clofentezine, hexythiazox, etoxazole, diafenthiuron, propargite, tetradifon, chlorfenapyr, DNOC, buprofezin, cyromazine, amitraz, hydramethylnon, acequinocyl, fluacrypyrim, rotenon, or their derivatives. Suitable fungicides are fungicides from the classes dinitroanilines, allylamines, anilinopyrimidines, antibiotics, aromatic hydro-carbons, benzenesulfonamides, benzimidazoles, benzoisothiazoles, benzophenones, benzothiadiazoles, benzotriazines, benzylcarbamates, carbamates, carboxamides, carboxylic acid amides, chloronitriles, cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino-)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenyl-acetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazole-carboxamides, thiocarbamates, thiophanates, thiophenecarboxamides, toluamides, triphenyltin compounds, triazines, triazoles. Suitable herbicides are herbicides from the classes of acetamides, amides, aryloxyphenoxypropionates, benzamides, benzofuran, benzoic acids, benzothiadiazinones, bipyridyliurn, carbamates, chloroacetamides, chlorocarboxylic acids, cyclohexanediones, dinitroanilines, dinitrophenol, diphenyl ethers, glycines, imidazolinones, isoxazoles, isoxazolidinones, nitriles, N-phenylphthalimides, oxadiazoles, oxazolidinediones, oxyacetamides, phenoxycarboxylic acids, phenyl-carbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas. Suitable classes of rodenticides comprise anticoagulants, inorganic rodenticides, organochlorine rodenticides, organophosphorus rodenticides, pyrimidinamine rodenticides, thiourea rodenticides, urea rodenticides.

In one embodiment, the pesticide comprises an insecticide; preferably, the pesticide consists of at least one insecticide. In a further embodiment, the pesticide comprises a fungicide; preferably, the pesticide consists of at least one fungicide. Preferred fungicides are pyraclostrobin, metconazole and epoxiconazole. In a further embodiment, the pesticide comprises a herbicide; preferably, the pesticide consists of at least one herbicide. In a further embodiment, the pesticide comprises a rodenticide, preferably an anticoagulant, in particular coumarin derivatives, especially preferably flocoumafen and difenacoum. Furthermore preferred are mixtures of an anticoagulant with ergocalciferol or vitamin D3.

The composition according to the invention usually comprises from 0.1 to 70% by weight of pesticide, preferably from 1 to 50% by weight, in particular from 3 to 30% by weight, based on the composition.

Generally, preservatives are those compounds which are added to agrochemical compositions in order to extend the shelf-life of the latter with regard to the effects of microorganisms (such as bacteria and fungi), insects and other small organisms. Preferred preservatives have a bactericidal and fungicidal, especially bactericidal, activity.

Examples of preservatives are benzoic acid, its esters and salts, para-hydroxybenzoic acid (paraben), its esters and salts, propionic acid and its salts, salicylic acid and its salts, 2,4-hexadienoic acid (sorbic acid) and its salt, formaldehyde and paraformaldehyde, 2-hydroxybiphenyl ether and its salts, 2-zincsulfidopyridine N-oxide, inorganic sulfites and bisulfites, sodium iodate, chlorobutanol, dehydraacetic acid, formic acid, 1,6-bis(4-amidino-2-bromophenoxy)-n-hexane and its salts, 10-undecylenic acid and its salts, 5-amino-1,3-bis(2-ethylhexyl)-5-methylhexahydropyrimidine, 5-bromo-5-nitro-1,3-dioxane, 2-bromo-2-nitropropane-1,3-diol, 2,4-dichlorobenzyl alcohol, N-(4-chlorophenyl)-N′-(3,4-dichlorophenyl)urea, 4-chloro-m-cresol, 2,4,4′-trichloro-2′-hydroxydiphenyl ether, 4-chloro-3,5-dimethylphenol, 1,1′-methylene-bis(3-(1-hydroxymethyl-2,4-dioximidazolidin-5-yl)urea), poly(hexamethylenediguanide) hydrochloride, 2-phenoxyethanol, hexamethylenetetramine, 1-(3-chloroallyl)-3,5,7-triaza-1-azonia-adamantane chloride, 1(4-chlorophenoxy)-1-(1H-imidazol-1-yl)-3,3-dimethyl-2-butanone, 1,3-bis(hydroxymethyl)-5,5-dimethyl-2,4-imidazolidinedione, benzyl alcohol, octopirox, 1,2-dibromo-2,4-dicyanobutane, 2,2′-methylenebis(6-bromo-4-chlorophenol), bromochlorophene, dichlorophene, 2-benzyl-4-chlorophenol, 2-chloroacetamide, chlorhexidine, chlorhexidine acetate, chlorhexidine gluconate, chlorhexidine hydrochloride, 1-phenoxypropan-2-ol, N-alkyl(C₁₂-C₂₂)trimethylammonium bromide and chloride, 4,4-dimethyl-1,3-oxazolidine, N-hydroxymethyl-N-(1,3-di(hydroxymethyl)-2,5-dioxoimidazolidin-4-yl)-N′-hydroxymethylurea, 1,6-bis(4-amidinophenoxy)-n-hexane and its salts, glutaraldehyde, 5-ethyl-1-aza-3,7-dioxabicyclo(3.3.0)octane, 3-(4-chlorophenoxy)propane-1,2-diol, Hyamine, alkyl(C₈-C₁₈)dimethylbenzylammonium chloride, alkyl(C₈-C₁₈)dimethylbenzylammonium bromide, alkyl(C₈-C₁₈)dimethylbenzylammonium saccharinate, benzyl hemiformal, 3-iodo-2-propynyl butylcarbamate, sodium hydroxymethylaminoacetate, cetyltrimethylammonium bromide, cetylpyridinium chloride, and derivatives of 2H isothiazol-3-one (so-called isothiazolone derivatives) such as alkylisothiazolones (for example 2-methyl-2H-isothiazol-3-one, MIT; chloro-2-methyl-2H-isothiazol-3-one, CIT), benzoisothiazolones (for example 1,2-benzoisothiazol-3(2H)-one, BIT, commercially available as Proxel® types from ICI) or 2-methyl-4,5-trimethylene-2H-isothiazol-3-one (MTIT), and mixtures of these.

Preferred preservatives are propionic acid and its salts, sorbic acid and its salts, benzoic acid, its esters and salts, para-hydroxybenzoic acid and its salts, C₁-C₄-alkyl para-hydroxybenzoate (alkylparabens) and isothiazolone derivatives and their mixtures, 2-phenoxyethanol, cetyltrimethylammonium bromide, cetylpyridinium chloride, benzyl hemiformal and dichlorophene. Especially preferred are C₁-C₄-alkyl para-hydroxybenzoate (alkylparabens) and isothiazolone derivatives and their mixtures, and 2-phenoxyethanol.

Very especially preferred preservatives are isothiazolone derivatives and their mixtures, such as alkyl isothiazolones (for example MIT, CIT), benzoisothiazolones (for example BIT), MTIT, mixtures of MIT and CIT or of MIT and BIT. Very especially preferred are mixtures of isothiazolone derivatives, such as mixtures of MIT and CIT or of MIT and BIT, specifically of MIT and BIT. Such mixtures are generally present in a weight ratio of from 10:1 to 1:10, preferably from 5:1 to 1:5 and specifically from 3:1 to 1:3.

The preservative concentration to be used depends on the preservative employed in each case. Therefore, suitable concentrations are mentioned in each case by the manufacturer or in the prior art, for example:
for Acticide® MBS from Thor GmbH (2.5% by weight BIT and 2.5% by weight MIT), an addition of 25-250 ppm of active substance (corresponding to 0.0025 to 0.025% by weight of the total of BIT and MIT) is recommended for agrochemical formulations.
for Acticide® MBL from Thor GmbH (2.5% by weight BIT, 2.5% by weight MIT and 8% by weight 2-bromo-2-nitropropane-1,3-diol), an addition of 0.05 to 0.5% by weight (corresponds to 0.0065 to 0.065% by weight of the total of the three active substances) is recommended for agrochemical formulations.
for Proxel® DL from Arch (9% by weight BIT solution), an addition of 0.1-0.5% by weight (corresponds to 0.0001 to 0.0045% by weight BIT) is recommended for agrochemical formulations.
for Proxel® BD20 from Arch (19.3% by weight BIT suspension), an addition of 0.1-0.5% by weight (corresponds to 0.0193 to 0.0965% by weight BIT) is recommended for agrochemical formulations.

The preservative concentration to be used in the composition according to the invention therefore also depends on the preservative employed in each case, but it is generally lower than recommended by the manufacturer of the preservative, or in the lower range of the manufacturer's recommendation. The skilled worker can determine a suitable concentration of the preservative in simple preliminary experiments: to this end, the shelf life of a composition without addition of 1,2-alkanediol and with addition of alkanediol and reduced preservative concentrations is tested. Then, the reduced preservative concentration which has an equally long shelf life as the composition without alkanediol is selected.

In general, the composition according to the invention comprises less than 0.5% by weight, preferably less than 0.1% by weight, especially preferably less than 0.05% by weight and in particular less than 0.02% by weight of preservative, based on the composition. In the case of preservative mixtures, the concentration data relates to the total of all preservatives. In the case of dilute aqueous preservatives, or preservatives which have been formulated in other ways, the concentration data relates to the pure preservatives.

In most cases, the composition according to the invention comprises formulation adjuvants, the choice of the adjuvants usually depending on the specific use form or on the active ingredient. Examples of suitable adjuvants are solvents, solid carriers, surface-active substances (such as surfactants, solubilizers, protective colloids, wetters and stickers), organic and inorganic thickeners, antifreeze agents, antifoams, optionally colorants and adhesives (for example for the treatment of seeds) or bait materials and attractants (for example for bait).

Suitable surface-active substances (adjuvants, wetters, stickers, dispersants or emulsifiers) are the alkali metal, alkaline earth metal and ammonium salts of aromatic sulfonic acids, for example of ligno- (Borresperse® types, Borregaard, Norway), phenol-, naphthalene- (Morwet® types, Akzo Nobel, USA) and dibutylnaphthalenesulfonic acid (Nekal® types, BASF, Germany), and of fatty acids, alkyl- and alkylarylsulfonates, alkyl sulfates, lauryl ether sulfates and fatty alcohol sulfates, and salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-sulfite waste liquors, and proteins, denatured proteins, polysaccharides (for example methylcellulose), hydrophobically modified starches, polyvinyl alcohol (Mowiol® types, Clariant, Switzerland), polycarboxylates (Sokalan® types, BASF, Germany), polyalkoxylates, polyvinylamine (Lupamin® types, BASF, Germany), polyethyleneimine (Lupasol® types, BASF, Germany), polyvinylpyrrolidone, and their copolymers.

Surfactants which are particularly suitable are anionic, cationic, nonionic and amphoteric surfactants, block polymers and polyelectrolytes. Suitable anionic surfactants are alkali metal, alkaline earth metal or ammonium salts of sulfonates, sulfates, phosphates or carboxylates. Examples of sulfonates are alkylarylsulfonates, diphenylsulfonates, alpha-olefinsulfonates, sulfonates of fatty acids and oils, sulfonates of ethoxylated alkylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates and carboxylated alcohol or alkylphenol ethoxylates.

Suitable nonionic surfactants are alkoxylates, N-alkylated fatty acid amides, amine oxides, esters or sugar-based surfactants. Examples of alkoxylates are compounds such as alcohols, alkylphenols, amines, amides, arylphenols, fatty acids or fatty acid esters which have been alkoxylated. Ethylene oxide and/or propylene oxide may be employed for the alkoxylation, preferably ethylene oxide. Examples of N-alkylated fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Suitable cationic surfactants are quaternary surfactants, for example quaternary ammonium compounds with one or two hydrophobic groups, or salts of long-chain primary amines. Suitable amphoteric surfactants are alkylbetaines and imidazolines. Suitable block polymers are block polymers of the A-B or A-B-A type comprising blocks of polyethylene oxide and polypropylene oxide or of the A-B-C type comprising alkanol, polyethylene oxide and polypropylene oxide. Suitable polyelectrolytes are polyacids or polybases. Examples of polyacids are alkali metal salts of polyacrylic acid. Examples of polybases are polyvinylamines or polyethyleneamines.

The composition according to the invention can comprise various amounts of surface-active substances and surfactants. It can comprise from 0.1 to 40% by weight, preferably from 1 to 30 and in particular from 2 to 20% by weight total amount of surface-active substances and surfactants, based on the total amount of the composition.

Examples of adjuvants are organically modified polysiloxanes such as BreakThruS 240®; alcohol alkoxylates such as Atplus®245, Atplus®MBA 1303, Plurafac®LF and Lutensol® ON; EO/PO block polymers, for example Pluronic® RPE 2035 and Genapol® B; alcohol ethoxylates, for example Lutensol® XP 80; and sodium dioctylsulfosuccinate, for example Leophen® RA.

Examples of thickeners (i.e. compounds which impart to the composition a modified flow behavior, i.e. high viscosity at rest and low viscosity in motion) are polysaccharides and organic and inorganic layer minerals such as xanthan gum (Kelzan®, CP Kelco), Rhodopol® 23 (Rhodia) or Veegum® (R.T. Vanderbilt) or Attaclay® (Engelhard Corp.).

Examples of suitable antifreeze agents are ethylene glycol, propylene glycol, urea and glycerol.

Examples of antifoams are silicone emulsions (such as, for example Silikon® SRE, Wacker, Germany or Rhodorsil®, Rhodia, France), long-chain alcohols, fatty acids, salts of fatty acids, organofluorine compounds and their mixtures.

Examples of colorants are both pigments, which are sparingly soluble in water, and dyes, which are soluble in water. Examples which may be mentioned are the dyes and pigments known by the names Rhodamin B, C. I. Pigment Red 112 and C. I. Solvent Red 1, Pigment Blue 15:4, Pigment Blue 15:3, Pigment Blue 15:2, Pigment Blue 15:1, Pigment Blue 80, Pigment Yellow 1, Pigment Yellow 13, Pigment Red 48:2, Pigment Red 48:1, Pigment Red 57:1, Pigment Red 53:1, Pigment Orange 43, Pigment Orange 34, Pigment Orange 5, Pigment Green 36, Pigment Green 7, Pigment White 6, Pigment Brown 25, Basic Violet 10, Basic Violet 49, Acid Red 51, Acid Red 52, Acid Red 14, Acid Blue 9, Acid Yellow 23, Basic Red 10, Basic Red 108.

Examples of stickers are polyvinylpyrrolidone, polyvinyl acetate, polyvinyl alcohol and cellulose ethers (Tylose®, Shin-Etsu, Japan).

Bait materials which are generally used are vegetable or animal foodstuffs and feedstuffs. Suitable examples are coarse cereal meals, cereal grains, flake cereals or cereal meals (for example of oats, wheat, barley, maize, soya, rice), flaked coconut, ground coconut, sugar syrups (for example obtained by hydrolyzing starch (glucose syrup), invert sugar syrup, beet sugar syrup, maple syrup), sugars (for example sucrose, lactose, fructose, glucose), grated nuts, ground nuts (for example hazelnut, walnut, almond), vegetable fat/oils (for example rapeseed oil, soya fat, sunflower oil, cocoa butter, peanut oil, peanut butter, corn oil), animal fats/oils (butter, lard, fish oil), proteins (for example dried skimmed milk, dried egg, protein hydrolyzates) and minerals (for example common salt).

Examples of attractants are pheromones, yeast, ground shell fish, fecal matter, berries, chocolate, fishmeal, meat, black pepper and flavor enhancers such as glutamates, in particular sodium glutamate and disodium glutamate.

Usually, the compositions according to the invention are present as compositions conventionally used for agrochemical application:

### 1. Compositions for Dilution in Water

i) Water-soluble concentrates (SL, LS): 10 parts by weight of the active substances are dissolved with 90 parts by weight of water or a water-soluble solvent. As an alternative, welters or other adjuvants are added. Upon dilution in water, the active substance dissolves. In this manner, a composition with an active substance content of 10% by weight is obtained.
ii) Dispersible concentrates (DC): 20 parts by weight of the active substances are dissolved in 70 parts by weight of cyclohexanone with addition of 10 parts by weight of a dispersant, for example polyvinylpyrrolidone. Upon dilution in water, a dispersion results. The active substance content is 20% by weight.
iii) Emulsifiable concentrates (EC): 15 parts by weight of the active substances are dissolved in 75 parts by weight of xylene with addition of calcium dodecylbenzenesulfonate and castor oil ethoxylate (in each case 5 parts by weight). Upon dilution in water, an emulsion results. The composition has an active substance content of 15% by weight.
iv) Emulsions (EW, EO, ES): 25 parts by weight of the active substances are dissolved in 35 parts by weight of xylene with addition of calcium dodecylbenzenesulfonate and castor oil ethoxylate (in each case 5 parts by weight). This mixture is placed into 30 parts by weight of water using an emulsifier (for example Ultra-Turrax) and made into a homogeneous emulsion. Upon dilution in water, an emulsion results. The composition has an active substance content of 25% by weight.
v) Suspensions (SC, OD, FS): 20 parts by weight of the active substances, with addition of 10 parts by weight of dispersants and wetters and 70 parts by weight of water or an organic solvent, are comminuted in an agitated ball mill to give a fine active substance suspension. Upon dilution in water, a stable suspension of the active substance results. The active substance content in the composition is 20% by weight.
vi) Water-dispersible and water-soluble granules (WG, SG): 50 parts by weight of the active substances are ground finely with addition of 50 parts by weight of dispersants and wetters and prepared as water-dispersible or water-soluble granules by means of technical apparatuses (for example extrusion, spray tower, fluidized-bed). Upon dilution in water, a stable dispersion or solution of the active substance results. The composition has an active substance content of 50% by weight.
vii) Water-dispersible and water-soluble powders (WP, SP, SS, WS): 75 parts by weight of the active substances, with addition of 25 parts by weight of dispersants and wetters and also silica gel, are ground in a rotor-stator mill. Upon dilution in water, a stable dispersion or solution of the active substance results. The composition has an active substance content of 75% by weight.
viii) Gels (GF): in a ball mill, 20 parts by weight of the active substances, 10 parts by weight of dispersant, 1 part by weight of gelling agent and 70 parts by weight of water or of an organic solvent are ground to give a fine suspension. Upon dilution with water, a stable suspension with an active substance content of 20% by weight results.

### 2. Compositions to be Applied Undiluted

ix) Dusts (DP, DS): 5 parts by weight of the active substances are ground finely and mixed intimately with 95 parts by weight of finely divided kaolin. This gives a dust with an active substance content of 5% by weight.
x) Granules (GR, FG, GG, MG): 0.5 part by weight of the active substances is ground finely and bound together with 99.5 parts by weight of carriers. Conventional processes for this purpose are extrusion, spray-drying or fluidized-bed. This gives granules to be applied undiluted, with an active substance content of 0.5% by weight.
xi) ULV solutions (UL): 10 parts by weight of the active substances are dissolved in 90 parts by weight of an organic solvent, for example xylene. This gives a composition to be applied undiluted, with an active substance content of 10% by weight.

Preferred are liquid compositions, such as water-soluble concentrates, emulsions or suspensions which comprise at least 10% by weight, preferably 20% by weight, especially preferably at least 40% by weight of water. In a further preferred embodiment, solid compositions such as baits, granules or gels which comprise at least 1% by weight, preferably at least 3% by weight, especially preferably at least 5% by weight of water, are preferred.

In most cases, the composition according to the invention will be diluted prior to application in order to prepare the so-called tank mix. Substances which are suitable for dilution are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone or water. It is preferred to use water. The dilute composition is usually applied by spraying or fogging. Oils of various types, wetters, adjuvants, herbicides, bactericides, fungicides may be added to the tank mix immediately prior to application (tank mix). These agents can be admixed to the compositions according to the invention in a weight ratio from 1:100 to 100:1, preferably 1:10 to 10:1. The pesticide concentration in the tank mix can be varied within substantial ranges. In general, they are between 0.0001 and 10%, preferably between 0.01 and 1%. When used in plant protection, the application rates are between 0.01 and 2.0 kg of active substance per ha, depending on the nature of the desired effect.

The present invention also relates to the use of a composition according to the invention for controlling phytopathogenic fungi and/or undesired plant growth and/or undesired insect or mite attack and/or for regulating the growth of plants, where the composition is allowed to act on the respective pests, their environment or the plants to be protected from the respective pest, the soil and/or on undesired plants and/or the useful plants and/or their environment. The invention furthermore relates to the use of a composition according to the invention for controlling undesired insect or mite attack on plants and/or for controlling phytopathogenic fungi and/or for controlling undesired plant growth, where seeds of useful plants are treated with the composition.

Furthermore, the invention relates to seed which has been treated, preferably dressed, with a composition according to the invention. By the treatment of seeds, a person skilled in the art understands the dressing of seeds, with the composition remaining on the seed. It is especially preferred that the seed comprises the composition according to the invention. This composition can be applied to the seed in undiluted or, preferably, diluted form. Here, the composition in question can be diluted 2- to 10-fold, so that from 0.01 to 60% by weight, preferably from 0.1 to 40% by weight, of pesticide are present in the compositions to be used for dressing the seed. The application can take place before sowing. The treatment of plant propagation material, in particular the treatment of seed, is known to the skilled worker and is carried out by dusting, coating, pelleting, dipping or soaking the plant propagation material, the treatment preferably being effected by pelleting, coating and dusting, so that, for example, premature germination of the seed is prevented. In the treatment of seed, one will generally use pesticide amounts of from 1 to 1000 g/100 kg, preferably from 5 to 100 g/100 kg propagation material or seed.

The invention furthermore relates to a process for the preparation of a composition according to the invention in which pesticide, preservative and unbranched 1,2-alkanediol having 5 to 10 carbon atoms are mixed. Preferred pesticides, preservatives and 1,2-alkanediols are as described above. The components are mixed by methods which are known to the skilled worker and which are usually employed for preparing the desired composition.

Furthermore, the invention relates to a use of unbranched 1,2-alkanediol having 5 to 10 carbon atoms for use in compositions comprising pesticide and preservative. The alkanediol is preferably used for increasing the bactericidal activity of the preservative. Preferably, the composition additionally comprises a formulation auxiliary. The pesticide is preferably a herbicide, insecticide or rodenticide, especially preferably a herbicide or rodenticide. The alkanediol is employed in the composition preferably for increasing the preserving activity of the preservative. The alkanediol is used especially preferably in the composition for increasing the preserving activity of isothiazolone derivatives and their mixtures, such as alkylisothiazolones (for example MIT, CIT), benzoisothiazolones (for example BIT), MTIT, mixtures of MIT and CIT or of MIT and BIT. Very especially preferred are mixtures of isothiazolone derivatives, such as mixtures of MIT and CIT or of MIT and BIT, specifically of MIT and BIT.

Advantages of the present invention are that the agrochemical composition features a reduced preservative concentration; that the antimicrobial activity of the preservative in the agrochemical composition itself is very high while the concentration is reduced; that the agrochemical composition can furthermore be formulated without problems; that the usual agrochemical formulation auxiliaries can be employed; that the usual agrochemical application techniques such as spraying or seed-dressing can be employed; and that the insecticidal or rodenticidal activity is not adversely affected by an undesired odor or flavor.

### EXAMPLES

Preservative: an aqueous formulation of 2.35-2.65% by weight of 2-methyl-4-isothiazolin-3-one (MIT) and 2.35-2.65% by weight of 1,2-benzoisothiazolin-3-one (BIT), commercially available from Thor under the name Acticide® MBS. The manufacturer recommends using a concentration of 0.2-0.4% by weight in aqueous products.

### Example 1

### Preparation of Agrochemical Formulations

First, in each case 2.0 l of the following aqueous suspension concentrates were prepared:
A) Suspension concentrate A (“SC A”)
   400 g/l pyrimethanil (fungicide)
   50 g/l sulfonate-comprising dispersant
   2 g/l thickener (xanthan gum)
   1.0 g/l silicone-comprising antifoam
   made up to 1000 ml with water
B) Suspension concentrate B (“SC B”)
   50 g/l fluquinconazole (fungicide)
   150 g/l pyrimethanil
   50 g/l sulfonate-comprising dispersant
   4 g/l thickener (xanthan gum)
   1.0 g/l silicone-comprising antifoam
   made up to 1000 ml with water

### Example 2

### Microbial Count Test on SC A

15 samples were prepared by mixing 100 g of suspension concentrate A with the preservative quantities detailed in table 1 (0.125 g/l, 0.25 g/1, 0.5 g/1, 1 g/l and 2 g/l) and PDO (10, 20 and 30 g/l). A sample only with suspension concentrate A was tested for control purposes.

In each case 10 ml of samples 1 to 16 were inoculated with a microorganism mixture consisting of various bacterial species (such as Bacillus subtilis, Escherchia coli, Pseudomonas aeruginosa, Staphylococcus aureus), homogenized and incubated at 23° C. The microbial count per gram of sample (cfu/g) was determined immediately and also after 24, 48 and 72 hours. To this end, in each case approximately 1 g of the contaminated sample was weighed accurately and streaked out in suitable dilutions on 2% strength malt extract agar. The contaminated sample was diluted by homogenization with sterile water. To detect the bacteria, the malt plates were incubated for 3 days at 23° C. The control without preservative and without PDO revealed a very high microbial count of markedly above 50 000 cfu/g. The results are compiled in table 1.

It was demonstrated that the activity of the preservative could be increased by admixing 1,2-pentanediol to the agrochemical formulation.

TABLE 1
Microbial counts [cfu/g]

| Amount of preservative | | 1.0 g PDO | 2.0 g PDO | 3.0 g PDO |
|---|---|---|---|---|
| 0.2 | g | free | free | free |
| 0.1 | g | >10000 | 212 | 21 |
| 0.05 | g | >10000 | 86 | 79 |
| 0.025 | g | >10000 | 1500 | 194 |
| 0.0125 | g | like control | like control | 627 |

### Example 3

### Microbial Count Test on SC B

The test was carried out as in example 2, with suspension concentrate B now being used in place of suspension concentrate A. The results are compiled in table 2. It was demonstrated that the activity of the preservative could be increased by admixing 1,2-pentanediol to the agrochemical formulation.

TABLE 2
Microbial counts [cfu/g]

| Amount of preservative | | 1.0 g PDO | 2.0 g PDO | 3.0 g PDO |
|---|---|---|---|---|
| 0.2 | g | 120 | free | free |
| 0.1 | g | 310 | 160 | free |
| 0.05 | g | >10000 | 300 | free |
| 0.025 | g | >50000 | 575 | free |
| 0.0125 | g | like control | 890 | free |

1-14. (canceled)

15: An agrochemical composition comprising pesticide, preservative and unbranched 1,2-alkanediol having 5 to 10 carbon atoms.

16: The composition according to claim 15, where the alkanediol is 1,2-pentanediol, 1,2-hexanediol, 1,2-octanediol or 1,2-decanediol.

17: The composition according to claim 16, where the alkanediol is 1,2-pentanediol.

18: The composition according to claim 17, which is liquid and comprises at least 10% by weight of water.

19: The composition according to claim 18, which comprises from 0.01 to 10% by weight of alkanediol.

20: The composition according to claim 19, which comprises less than 0.5% by weight of preservative.

21: The composition according to claim 15, where the preservative is propionic acid or a salt thereof, sorbic acid or a salt thereof, benzoic acid or an ester or a salt thereof, para-hydroxybenzoic acid or a salt thereof, C₁-C₄-alkyl para-hydroxybenzoate, an isothiazolone derivative, 2-phenoxyethanol, cetyltrimethylammonium bromide, cetylpyridinium chloride, benzyl hemiformal, dichlorophene or combinations thereof.

22: The composition according to claim 21, where the preservative is an isothiazolone derivative or their mixture.

23: The composition according to claim 15, where the pesticide is a fungicide, insecticide, rodenticide or herbicide.

24: The composition according to claim 23, where the alkanediol is 1,2-pentanediol, 1,2-hexanediol, 1,2-octanediol or 1,2-decanediol.

25: The composition according to claim 24, where the alkanediol is 1,2-pentanediol.

26: The composition according to claim 25, which, is liquid and comprises at least 10% by weight of water.

27: The composition according to claim 26, which comprises from 0.01 to 10% by weight of alkanediol.

28: The composition according to claim 27, which comprises less than 0.5% by weight of preservative.

29: A method for controlling phytopathogenic fungi and/or undesired plant growth and/or undesired insect or mite attack and/or for regulating the growth of plants, comprising allowing the composition of claim 15 to act on the respective pests, their environment or the plants to be protected from the respective pests, the soil, on undesired plants, the useful plants and/or their environment.

30: The method of claim 29, where the pesticide is a fungicide, insecticide, rodenticide or herbicide.

31: The method of claim 32, wherein the alkanediol is 1,2-pentanediol.

32: The method of claim 31, which comprises less than 0.5% by weight of preservative.

33: A method for controlling undesired insect or mite attack on plants and/or for controlling phytopathogenic fungi and/or for controlling undesired plant growth, comprising treating seeds of useful plants with the composition of claim 15.

34: A seed treated with the composition according to claim 15.
